(19) United States
(12) Patent Application Publication
(10) Pub. No.: US 2026/0177658 A1
(43) Pub. Date: Jun. 25, 2026

(54) ELECTRONIC DEVICE, METHOD FOR CONTROLLING ELECTRONIC DEVICE, AND PROGRAM

(71) Applicant: KYOCERA Corporation, Kyoto (JP)

(72) Inventors: Takuya HOMMA, Yokohama-shi, Kanagawa (JP); Tooru SAHARA, Yokohama-shi, Kanagawa (JP); Jun KURODA, Kodaira-shi, Tokyo (JP); Yuu KASHIMA, Yokohama-shi, Kanagawa (JP)

(73) Assignee: KYOCERA Corporation, Kyoto (JP)

(21) Appl. No.: 19/121,385

(22) PCT Filed: Oct. 11, 2023
(86) PCT No.: PCT/JP2023/036922

§ 371 Date: Apr. 15, 2025

(30) Foreign Application Priority Data
Oct. 19, 2022 (JP) 2022-167962

(51) Int. Cl. G01S 7/02; G01S 7/41; G01S 13/88; G01S 13/931

(52) U.S. Cl. CPC G01S 7/023; G01S 7/414; G01S 13/88; G01S 13/931

(57) ABSTRACT

An electronic device includes a controller. The controller detects an object, based on a transmission signal transmitted as a transmission wave and a reception signal received as a reflected wave that is the transmission wave having been reflected off the object. The controller detects the object, based on a difference between a logarithmic value of a first signal intensity of a first signal and a logarithmic value of a second signal intensity of a second signal. The first signal intensity corresponds to a distance of the object from the electronic device. The first signal is calculated based on a first transmission signal transmitted at a first time and a first reception signal received as the reflected wave of the first transmission signal. The second signal intensity corresponds to the distance of the object from the electronic device. The second signal is calculated based on a second transmission signal transmitted at a second time earlier than the first time and a second reception signal received as the reflected wave of the second transmission signal.

### CROSS-REFERENCE TO RELATED APPLICATIONS

This application claims priority from Japanese Patent Application No. 2022-167962 filed in Japan on Oct. 19, 2022, the entire disclosure of which is incorporated herein by reference.

### TECHNICAL FIELD

The present disclosure relates to an electronic device, a method for controlling an electronic device, and a program.

### BACKGROUND OF INVENTION

For example, in fields such as automobile-related industries, a technology for measuring a distance or the like between a vehicle of interest and a predetermined object is regarded as important. Recently, various studies have been conducted particularly on a radar (Radio Detecting and Ranging) technology for measuring a distance or the like to an object such as an obstacle by transmitting a radio wave such as a millimeter wave and then receiving a reflected wave reflected off the object. Such a technology for measuring a distance or the like is expected to be more important in the future with progresses of a technology for assisting drivers in driving and an automated-driving-related technology for partially or entirely automating driving.

Various suggestions have been made in relation to a technology for detecting the presence of a predetermined object by receiving a reflected wave of a radio wave that has been transmitted and reflected off the object. For example, Patent Literature 1 discloses an apparatus that stores past data of reflected waves as a map, with which the apparatus suppresses clutter. Patent Literature 2 discloses a radar apparatus that recognizes multiple targets to distinguish between a moving object and a stationary object, and measures a distance and a velocity of each of the objects.

### CITATION LIST

### Patent Literature

Patent Literature 1: Japanese Unexamined Patent Application Publication No. 60-093975
Patent Literature 2: Japanese Unexamined Patent Application Publication No. 2000-180536

### SUMMARY

In an embodiment, an electronic device includes a controller.

The controller detects an object, based on a transmission signal transmitted as a transmission wave and a reception signal received as a reflected wave that is the transmission wave having been reflected off the object.

The controller detects the object, based on a difference between a logarithmic value of a first signal intensity of a first signal and a logarithmic value of a second signal intensity of a second signal. The first signal intensity corresponds to a distance of the object from the electronic device. The first signal is calculated based on a first transmission signal transmitted at a first time and a first reception signal received as the reflected wave of the first transmission signal.

The second signal intensity corresponds to the distance of the object from the electronic device. The second signal is calculated based on a second transmission signal transmitted at a second time earlier than the first time and a second reception signal received as the reflected wave of the second transmission signal.

In an embodiment, a method for controlling an electronic device is for
detecting an object, based on a transmission signal transmitted as a transmission wave and a reception signal received as a reflected wave that is the transmission wave having been reflected off the object.

The method includes
detecting the object, based on a difference between a logarithmic value of a first signal intensity of a first signal and a logarithmic value of a second signal intensity of a second signal. The first signal intensity corresponds to a distance of the object from the electronic device. The first signal is calculated based on a first transmission signal transmitted at a first time and a first reception signal received as the reflected wave of the first transmission signal.

The second signal intensity corresponds to the distance of the object from the electronic device. The second signal is calculated based on a second transmission signal transmitted at a second time earlier than the first time and a second reception signal received as the reflected wave of the second transmission signal.

In an embodiment, a program causes a computer to
detect an object, based on a transmission signal transmitted as a transmission wave and a reception signal received as a reflected wave that is the transmission wave having been reflected off the object.

The program causes the computer to execute:
detecting the object, based on a difference between a logarithmic value of a first signal intensity of a first signal and a logarithmic value of a second signal intensity of a second signal. The first signal intensity corresponds to a distance of the object from the electronic device. The first signal is calculated based on a first transmission signal transmitted at a first time and a first reception signal received as the reflected wave of the first transmission signal.

The second signal intensity corresponds to the distance of the object from the electronic device. The second signal is calculated based on a second transmission signal transmitted at a second time earlier than the first time and a second reception signal received as the reflected wave of the second transmission signal.

### BRIEF DESCRIPTION OF THE DRAWINGS

FIG. 1 is a diagram for describing how an electronic device is used in an embodiment.

FIG. 2 is a functional block diagram schematically illustrating a configuration of the electronic device in an embodiment.

FIG. 3 is a functional block diagram illustrating part of the configuration of the electronic device in an embodiment.

FIG. 4 is a diagram for describing a configuration of a transmission signal in an embodiment.

FIG. 5 is a flowchart for describing an operation of the electronic device in an embodiment.

FIG. 6 is a graph illustrating a comparative example for describing a processing result obtained by a controller in an embodiment.

FIG. 7 is a graph illustrating a comparative example for describing a processing result obtained by the controller in an embodiment.

FIG. 8 is a graph illustrating a comparative example for describing a processing result obtained by the controller in an embodiment.

FIG. 9 is a graph illustrating a comparative example for describing a processing result obtained by the controller in an embodiment.

FIG. 10 is a graph illustrating an example of processing performed in the controller in an embodiment.

FIG. 11 is a graph illustrating an example of processing performed in the controller in an embodiment.

FIG. 12 is a graph illustrating an example of processing performed in the controller in an embodiment.

FIG. 13 is a graph illustrating an example of processing performed in the controller in an embodiment.

### DESCRIPTION OF EMBODIMENTS

A technology such as the radar described above is desirably capable of detecting a predetermined object with good accuracy by receiving a reflected wave that is a transmitted transmission wave reflected off the object. The present disclosure provides an electronic device, a method for controlling an electronic device, and a program that can detect an object with good accuracy. According to an embodiment, an electronic device, a method for controlling an electronic device, and a program that can detect an object with good accuracy can be provided. An embodiment is described in detail below with reference to the drawings.

In an embodiment, an electronic device is attached to, for example, a stationary structure (stationary object) and thus is capable of detecting a predetermined object located around the stationary object. The stationary object may be, for example, any device such as a traffic light installed at an intersection or a roadside unit or may be, for example, any portion such as a floor, a wall, or a ceiling of an indoor space. Thus, in an embodiment, the electronic device is capable of transmitting a transmission wave to an area around the stationary object from a transmission antenna installed on or in the stationary object. In an embodiment, the electronic device is also capable of receiving a reflected wave that is the reflected transmission wave, from a reception antenna installed on or in the stationary object. For example, a radar sensor or the like installed on or in the stationary object may include at least one of the transmission antenna or the reception antenna.

As a typical example, a configuration in which the electronic device in an embodiment is attached to a stationary structure is described below. An object detected by the electronic device in an embodiment may be an automobile or the like located around the electronic device attached to a stationary object, for example. The object detected by the electronic device in an embodiment is not limited to an automobile. The object detected by the electronic device in an embodiment may be any of various objects such as an autonomous car, a bus, a truck, a motorcycle, a bicycle, a ship, an aircraft, an agricultural machinery such as a tractor, a snowplow, a garbage truck, a police car, an ambulance, a fire engine, a helicopter, and a drone. In an embodiment, the electronic device is capable of measuring a distance or the like between the electronic device and an object located around the electronic device attached to the stationary object when the object is movable. In an embodiment, the electronic device is also capable of measuring a distance or the like between the electronic device and the object when both the electronic device and the object are stationary.

In general, with a technology such as a radar, a relative velocity between a device of interest and a target object (object) can be determined. In particular, a sensor that employs a technology such as a millimeter-wave radar has a velocity resolution performance. Such a sensor can detect a target object moving with respect to the device of interest with good accuracy. However, distinguishing between a target object that is stationary with respect to the device of interest and an object that has been present as a background may be difficult. In such a case, the above-described sensor may fail to appropriately detect the target object that is stationary with respect to the device of interest.

For example, when a sensor of a millimeter-wave radar is installed at a traffic light or a roadside unit on a road, the sensor operates with being fixed (stationary) with respect to the ground. In this case, the sensor can detect an automobile or a pedestrian moving on the road. However, for example, when a fallen tree is present on the road, and for example, an object that has fallen from a traveling truck or the like is present on the road, distinguishably detecting these stationary objects from a stationary object that has been present as a background may be difficult. In this case, the sensor may have difficulty detecting a potential hazard on the road. For this reason, desirably, a stationary object that is not present normally (that is, a stationary object that is temporarily present) can be distinguishably detected from a stationary object that has been present.

Accordingly, in an embodiment described below, an electronic device can distinguishably detect a stationary object that is not present normally (that is, a stationary object that is temporarily present) from a stationary object that has been present. In an embodiment, the electronic device can distinguishably detect, for example, a stationary object such as a fallen tree on a road or an object that has fallen from a traveling truck or the like, from a stationary object that has been present as a background.

An example of how the electronic device detects an object in an embodiment is described.

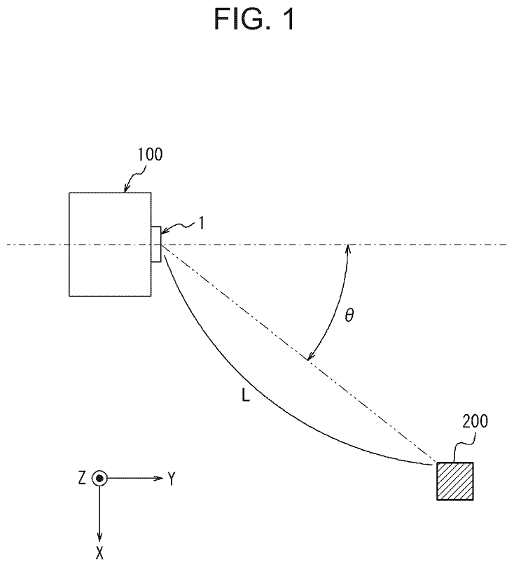

FIG. 1 is a diagram for describing how the electronic device is used in an embodiment. FIG. 1 illustrates an example in which an electronic device in an embodiment having functions of a sensor including a transmission antenna and a reception antenna is installed on a stationary object.

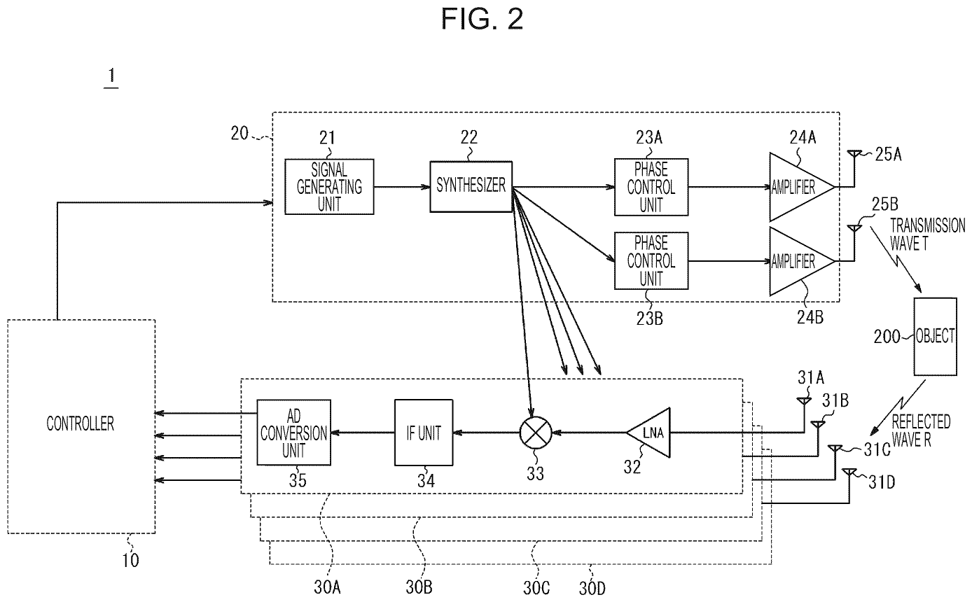

An electronic device 1 having functions of a sensor including a transmission antenna and a reception antenna in an embodiment is installed on a stationary object 100 illustrated in FIG. 1. For example, the stationary object 100 illustrated in FIG. 1 may include the electronic device 1 therein in an embodiment. A specific configuration of the electronic device 1 is described later. The electronic device 1 may include at least one of the transmission antenna or the reception antenna, for example. The electronic device 1 may appropriately include at least any of other functional units, such as at least part of a controller 10 (FIG. 2) included in the electronic device 1. The electronic device 1 may include at least any of other functional units, such as at least part of the controller 10 (FIG. 2) included in the electronic device 1, installed outside the electronic device 1. The stationary object 100 illustrated in FIG. 1 may be, for example, a structure such as a traffic light installed at an intersection or a roadside unit but may be a structure of any type. In FIG. 1, the stationary object 100 may be stationary without moving.

As illustrated in FIG. 1, the electronic device 1 including the transmission antenna is installed on the stationary object 100. In the example illustrated in FIG. 1, only one electronic device 1 including the transmission antenna and the reception antenna is installed in a positive Y-axis direction of the stationary object 100. The position where the electronic device 1 is installed on the stationary object 100 is not limited to the position illustrated in FIG. 1 and may be another appropriate position. The number of such electronic devices 1 may be any number equal to or greater than 1 depending on various conditions (or requirements) such as a range and/or an accuracy of measurement performed at the stationary object 100.

As described later, the electronic device 1 transmits an electromagnetic wave as a transmission wave from the transmission antenna. For example, when a predetermined object (for example, an object 200 illustrated in FIG. 1) is located around the stationary object 100, at least part of the transmission wave transmitted from the electronic device 1 is reflected off the object to become a reflected wave. For example, the reception antenna of the electronic device 1 receives such a reflected wave. In this manner, the electronic device 1 attached to the stationary object 100 can detect the object as a target.

The electronic device 1 including the transmission antenna may be typically a radar (Radio Detecting and Ranging) sensor that transmits and receives a radio wave. However, the electronic device 1 is not limited to a radar sensor. In an embodiment, the electronic device 1 may be, for example, a sensor based on the LIDAR (Light Detection and Ranging, Laser Imaging Detection and Ranging) technology that uses an optical wave. Each of these sensors can include, for example, a patch antenna. Since the technologies such as the radar and the LIDAR are already known, detailed description may be appropriately simplified or omitted.

The electronic device 1 attached to the stationary object 100 illustrated in FIG. 1 receives, from the reception antenna, the reflected wave of the transmission wave transmitted from the transmission antenna. In this manner, the electronic device 1 can detect, as the target, the predetermined object 200 located within a predetermined distance from the stationary object 100. For example, as illustrated in FIG. 1, the electronic device 1 can measure a distance L between the stationary object 100 and the predetermined object 200. The electronic device 1 can also measure a relative velocity of the predetermined object 200 with respect to the stationary object 100. The electronic device 1 can further measure a direction (an angle of arrival θ) from which the reflected wave from the predetermined object 200 arrives at the stationary object 100.

The object 200 may be, for example, an automobile or the like that travels around the stationary object 100. The object 200 may also be any object located around the stationary object 100, such as a motorcycle, a bicycle, a stroller, a person such as a pedestrian, an animal, other forms of life such as an insect, a guardrail, a median strip, a road sign, a step on a sidewalk, a wall, a maintenance hole, a structure such as a house, a building, or a bridge, or an obstacle. The object 200 may be in motion or may be stopped or stationary. For example, the object 200 may be an automobile or the like that is parked or stationary around the stationary object 100. The object 200 may be located not only at a roadway but also at an appropriate place such as on a sidewalk, in a farm, on a farmland, in a parking lot, in a vacant lot, in a space above a road, in a store, at a crosswalk, on the water, in the air, in a gutter, in a river, in another mobility device, in a building, inside or outside of other structures. In the present disclosure, the object detected by the electronic device 1 includes living things such as a person, a dog, a cat, a horse, and other animals in addition to non-living things. In the present disclosure, the object detected by the electronic device 1 includes a target, which includes a person, an object, and an animal, to be detected with the radar technology.

In FIG. 1, a ratio between a size of the electronic device 1 and a size of the stationary object 100 does not necessarily indicate an actual ratio. FIG. 1 illustrates the electronic device 1 that is installed on an outer portion of the stationary object 100. However, in an embodiment, the electronic device 1 may be installed at various positions of the stationary object 100. For example, in an embodiment, the electronic device 1 may be installed inside the stationary object 100 so as not to appear in the appearance of the stationary object 100.

A typical example is described blow in which the transmission antenna of the electronic device 1 transmits a radio wave in a frequency band, such as a millimeter wave (equal to or higher than 30 GHz) or a quasi-millimeter wave (for example, around 20 GHz to 30 GHz). For example, the transmission antenna of the electronic device 1 may transmit a radio wave having a frequency bandwidth of 4 GHz such as from 77 GHz to 81 GHz.

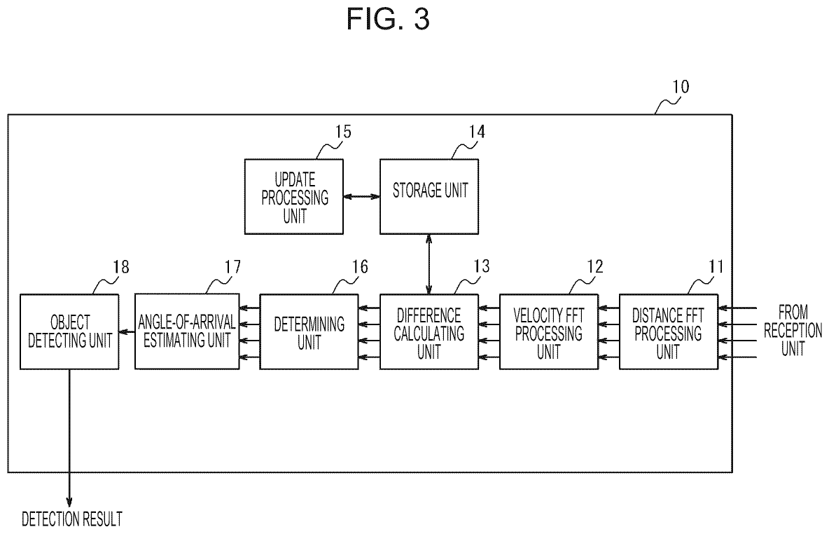

FIG. 2 is a functional block diagram schematically illustrating a configuration example of the electronic device 1 in an embodiment. FIG. 3 is a functional block diagram illustrating in detail the controller 10 of the electronic device 1 illustrated in FIG. 2. An example of the configuration of the electronic device 1 in an embodiment is described below.

When a distance or the like is measured by using a millimeter-wave radar, a frequency-modulated continuous wave radar (hereinafter, referred to as an FMCW radar) is often used. The FMCW radar sweeps a frequency of a to-be-transmitted radio wave to generate a transmission signal. Thus, a frequency of the radio wave used by such a millimeter-wave FMCW radar, which uses a radio wave of a frequency band of 79 GHz, for example, has a frequency bandwidth of 4 GHz such as from 77 GHz to 81 GHz, for example. The radar of the frequency band of 79 GHz has a feature that a usable frequency bandwidth is wider than other millimeter-wave and/or quasi-millimeter-wave radars of frequency bands of 24 GHz, 60 GHz, and 76 GHz, for example. Such an embodiment is described below as an example. The FMCW radar scheme used in the present disclosure may include an FCM scheme (Fast-Chirp Modulation) for transmitting chirp signals at a shorter period than usual. A signal generated by a signal generating unit 21 is not limited to a signal of the FM-CW scheme. The signal generated by the signal generating unit 21 may be a signal of any of various schemes other than the FM-CW scheme. A transmission signal sequence stored in any storage unit may change in accordance with these various schemes. For example, in the case of a radar signal of the FM-CW scheme described above, a signal whose frequency increases for each time sample and a signal whose frequency decreases for each time sample may be used. More detailed description of the various schemes described above is omitted because known techniques can be appropriately employed.

As illustrated in FIG. 2, in an embodiment, the electronic device 1 includes the controller 10. In an embodiment, the electronic device 1 may also appropriately include another functional unit such as at least any of a transmission unit 20 or reception units 30A to 30D. As illustrated in FIG. 2, the electronic device 1 may include multiple reception units such as the reception units 30A to 30D. When the reception units 30A, 30B, 30C, and 30D are not distinguished from one another, the reception units 30A, 30B, 30C, and 30D are simply referred to as “reception units 30” below.

As illustrated in FIG. 3, the controller 10 may include a distance FFT processing unit 11, a velocity FFT processing unit 12, a difference calculating unit 13, a storage unit 14, an update processing unit 15, a determining unit 16, an angle-of-arrival estimating unit 17, and an object detecting unit 18. These functional units included in the controller 10 are further described later.

As illustrated in FIG. 2, the transmission unit 20 may include the signal generating unit 21, a synthesizer 22, phase control units 23A and 23B, amplifiers 24A and 24B, and transmission antennas 25A and 25B. When the phase control units 23A and 23B are not distinguished from each other, the phase control units 23A and 23B are simply referred to as “phase control units 23” below. When the amplifiers 24A and 24B are not distinguished from each other, the amplifiers 24A and 24B are simply referred to as “amplifiers 24” below. When the transmission antennas 25A and 25B are not distinguished from each other, the transmission antennas 25A and 25B are simply referred to as “transmission antennas 25” below.

As illustrated in FIG. 2, each of the reception units 30 may include a respective one of reception antennas 31A to 31D. When the reception antennas 31A, 31B, 31C, and 31D are not distinguished from one another, the reception antennas 31A, 31B, 31C, and 31D are simply referred to as “reception antennas 31” below. As illustrated in FIG. 2, each of the multiple reception units 30 may include an LNA 32, a mixer 33, an IF unit 34, and an AD conversion unit 35. The reception units 30A to 30D may have the same and/or similar configuration. FIG. 2 schematically illustrates the configuration of only the reception unit 30A as a representative example.

The electronic device 1 described above may include, for example, the transmission antennas 25 and the reception antennas 31. The electronic device 1 may also appropriately include at least any of other functional units such as the controller 10.

In an embodiment, the controller 10 included in the electronic device 1 is capable of controlling the individual functional units of the electronic device 1 and controlling operations of the entire electronic device 1. In an embodiment, the controller 10 may include a function of performing various kinds of signal processing on a reception signal received as a reflected wave by the reception unit 30. To provide control and processing capabilities for executing various functions, the controller 10 may include at least one processor, for example, a CPU (Central Processing Unit) or a DSP (Digital Signal Processor). The controller 10 may be collectively implemented by one processor, may be implemented by some processors, or may be implemented by discrete individual processors. The processor may be implemented as one integrated circuit. The integrated circuit is also referred to as an IC. The processor may be implemented as multiple integrated circuits and discrete circuits connected to be able to perform communication. The processor may be implemented based on various other known technologies. In an embodiment, the controller 10 may be configured as, for example, a CPU and a program executed by the CPU. The controller 10 may appropriately include a memory (any storage unit) necessary for operations of the controller 10.

The any storage unit (the memory necessary for operations of the controller 10) may store a program executed by the controller 10, results of processing performed by the controller 10, and so on. The any storage unit may function as a work memory of the controller 10. The any storage unit can be implemented by a semiconductor memory or a magnetic disk, for example. However, the any storage unit is not limited to these devices, and may be implemented by any storage device. The any storage unit may be, for example, a storage medium such as a memory card inserted to the electronic device 1 according to the present embodiment. The any storage unit may be an internal memory of the CPU used as the controller 10 as described above.

In an embodiment, the any storage unit may store various parameters for setting a range in which an object is detected based on a transmission wave T transmitted from each transmission antenna 25 and a reflected wave R received from each reception antenna 31.

In an embodiment, in the electronic device 1, the controller 10 is capable of controlling at least one of the transmission unit 20 or the reception units 30. In this case, the controller 10 may control at least one of the transmission unit 20 or the reception units 30, based on various kinds of information stored in the any storage unit. In an embodiment, in the electronic device 1, the controller 10 may instruct the signal generating unit 21 to generate a signal or may control the signal generating unit 21 to generate a signal.

In accordance with control performed by the controller 10, the signal generating unit 21 generates a signal (transmission signal) to be transmitted as the transmission wave T from each of the transmission antennas 25. When generating a transmission signal, the signal generating unit 21 may allocate a frequency of the transmission signal, in accordance with control performed by the controller 10, for example. Specifically, the signal generating unit 21 may allocate the frequency of the transmission signal in accordance with a parameter set by the controller 10, for example. For example, the signal generating unit 21 receives frequency information from the controller 10 or the any storage unit and generates a signal having a predetermined frequency in a frequency band such as from 77 GHz to 81 GHz, for example. The signal generating unit 21 may include a functional unit such as a voltage control oscillator (VCO), for example.

The signal generating unit 21 may be configured as hardware having the function, as a microcomputer for example, or as a processor such as a CPU and a program or the like executed by the processor for example. Each functional unit described below may also be configured as hardware having the function, as a microcomputer for example if possible, or as a processor such as a CPU and a program or the like executed by the processor for example.

In an embodiment, in the electronic device 1, the signal generating unit 21 may generate a transmission signal (transmission chirp signal) such as a chirp signal, for example. In particular, the signal generating unit 21 may generate a signal (linear chirp signal) whose frequency changes linearly and periodically. For example, the signal generating unit 21 may adopt a chirp signal whose frequency linearly and periodically increases from 77 GHz to 81 GHz as time elapses. For example, the signal generating unit 21 may generate a signal whose frequency periodically repeats a linear increase (up-chirp) from 77 GHz to 81 GHz and a decrease (down-chirp) as time elapses. For example, the controller 10 may set in advance the signal to be generated by the signal generating unit 21. For example, the any storage unit or the like may store in advance the signal to be generated by the signal generating unit 21. Since a chirp signal used in a technical field such as the radar is known, more detailed description is appropriately simplified or omitted. The signal generated by the signal generating unit 21 is supplied to the synthesizer 22.

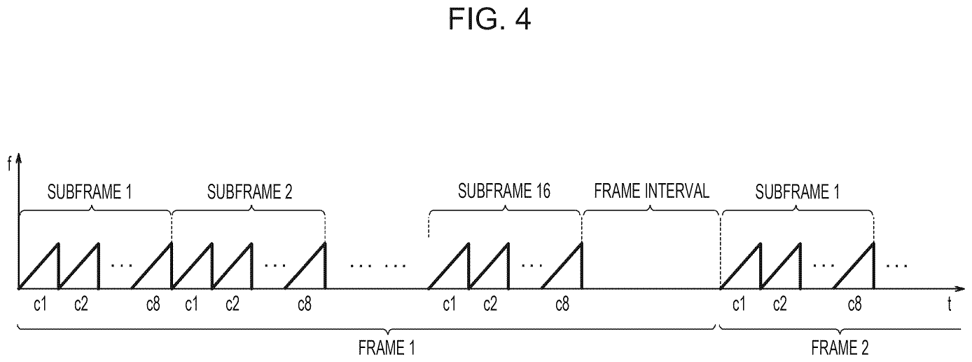

FIG. 4 is a diagram for describing an example of chirp signals generated by the signal generating unit 21.

In FIG. 4, the horizontal axis represents elapsed time and the vertical axis represents a frequency. In the example illustrated in FIG. 4, the signal generating unit 21 generates linear chirp signals whose frequency changes linearly and periodically. FIG. 4 illustrates chirp signals c1, c2, . . . , c8. As illustrated in FIG. 4, the frequency of each chirp signal linearly increases as time elapses.

In the example illustrated in FIG. 4, one subframe includes eight chirp signals c1, c2, . . . , c8. That is, each of subframes such as a subframe 1 and a subframe 2 illustrated in FIG. 4 includes eight chirp signals c1, c2, . . . , c8. In the example illustrated in FIG. 4, one frame includes 16 subframes such as the subframes 1 to 16. That is, each of frames such as a frame 1 and a frame 2 illustrated in FIG. 4 includes 16 subframes. As illustrated in FIG. 4, a frame interval of a predetermined length may be included between frames. One frame illustrated in FIG. 4 may have a length of about 30 ms to 50 ms, for example.

In FIG. 4, the frame 2 and subsequent frames may have the same and/or similar configuration. In FIG. 4, the frame 3 and subsequent frames may have the same and/or similar configuration. In an embodiment, in the electronic device 1, the signal generating unit 21 may generate a transmission signal as any number of frames. In FIG. 4, an illustration of some chirp signals is omitted. As described above, for example, the any storage unit or the like may store a relationship between time and a frequency of the transmission signal generated by the signal generating unit 21.

As described above, in an embodiment, the electronic device 1 may transmit a transmission signal made up of subframes each including multiple chirp signals. In an embodiment, the electronic device 1 may transmit a transmission signal made up of frames each including a predetermined number of subframes.

In the description below, the electronic device 1 transmits a transmission signal having a frame structure illustrated in FIG. 4. However, the frame structure illustrated in FIG. 4 is an example. For example, the number of chirp signals included in one subframe is not limited to eight. In an embodiment, the signal generating unit 21 may generate a subframe including any number of (for example, multiple) chirp signals. The subframe structure illustrated in FIG. 4 is also an example. For example, the number of subframes included in one frame is not limited to 16. In an embodiment, the signal generating unit 21 may generate a frame including any number of (for example, multiple) subframes. The signal generating unit 21 may generate signals having different frequencies. The signal generating unit 21 may generate multiple discrete signals of bandwidths in which frequencies f are different from each other.

Referring back to FIG. 2, the synthesizer 22 increases the frequency of the signal generated by the signal generating unit 21 to a frequency in a predetermined frequency band. The synthesizer 22 may increase the frequency of the signal generated by the signal generating unit 21 to a frequency selected as a frequency of the transmission wave T to be transmitted from each of the transmission antennas 25. For example, the controller 10 may set the frequency selected as the frequency of the transmission wave T to be transmitted from each of the transmission antennas 25. For example, the any storage unit may store the frequency selected as the frequency of the transmission wave T to be transmitted from each of the transmission antennas 25. The signal whose frequency has been increased by the synthesizer 22 is supplied to the phase control unit 23 and the mixer 33. When the multiple phase control units 23 are present, the signal whose frequency has been increased by the synthesizer 22 may be supplied to each of the multiple phase control units 23. When the multiple reception units 30 are present, the signal whose frequency has been increased by the synthesizer 22 may be supplied to the mixer 33 of each of the multiple reception units 30.

Each of the phase control units 23 controls a phase of the transmission signal supplied from the synthesizer 22. Specifically, for example, in accordance with control performed by the controller 10, each of the phase control units 23 may appropriately advance or delay the phase of the signal supplied from the synthesizer 22 to adjust the phase of the transmission signal. In this case, based on a difference between paths of the respective transmission waves T to be transmitted from the multiple transmission antennas 25, the phase control units 23 may adjust the phases of the respective transmission signals. The phase control units 23 appropriately adjust the phases of the respective transmission signals, so that the transmission waves T transmitted from the multiple transmission antennas 25 enhance with each other in a predetermined direction to form a beam (beamforming). In this case, for example, the any storage unit may store a correlation between a direction of beamforming and amounts of phase by which the respective transmission signals transmitted by the multiple transmission antennas 25 are to be controlled. The transmission signal whose phase is controlled by each of the phase control units 23 is supplied to a respective one of the amplifiers 24.

The amplifier 24 amplifies power (electric power) of the transmission signal supplied from the phase control unit 23 in accordance with control performed by the controller 10, for example. When the electronic device 1 includes the multiple transmission antennas 25, each of the multiple amplifiers 24 may amplify power (electric power) of the transmission signal supplied from a respective one of the multiple phase control units 23 in accordance with control performed by the controller 10, for example. Since the technology for amplifying power of a transmission signal is already known, more detailed description is omitted. Each of the amplifiers 24 is connected to a respective one of the transmission antennas 25.

The transmission antenna 25 outputs (transmits), as the transmission wave T, the transmission signal amplified by the amplifier 24. When the electronic device 1 includes the multiple transmission antennas 25, each of the multiple transmission antennas 25 may output (transmit), as the transmission wave T, the transmission signal amplified by a respective one of the multiple amplifiers 24. Since the transmission antennas 25 can be configured in a same manner as and/or similar manner to transmission antennas for use in the known radar technology, more detailed description is omitted.

Thus, in an embodiment, the electronic device 1 includes the transmission antennas 25 and can transmit transmission signals (for example, transmission chirp signals) as the transmission waves T from the respective transmission antennas 25. At least one of the functional units of the electronic device 1 may be housed in one housing. In this case, the one housing may have a hard-to-open structure. For example, the transmission antennas 25, the reception antennas 31, and the amplifiers 24 are desirably housed in one housing, and this housing desirably has a hard-to-open structure. When the electronic device 1 is installed on the stationary object 100, each of the transmission antennas 25 may transmit the transmission wave T to outside the stationary object 100 through a cover member such as a radar cover, for example. In this case, the radar cover may be made of a material, for example, a synthetic resin or rubber, that allows an electromagnetic wave to pass therethrough. This radar cover may also serve as a housing of the electronic device 1, for example. Covering the transmission antennas 25 with a member such as the radar cover can reduce a risk of the transmission antennas 25 being damaged or malfunctioning because of a contact with an external object. The radar cover and the housing may also be referred to as a radome.

FIG. 2 illustrates an example of the electronic device 1 that includes two transmission antennas 25. However, in an embodiment, the electronic device 1 may include any number of transmission antennas 25. On the other hand, in an embodiment, the electronic device 1 may include the multiple transmission antennas 25 when the transmission waves T transmitted from the respective transmission antennas 25 form a beam in a predetermined direction. In an embodiment, the electronic device 1 may include any number of (multiple) transmission antennas 25. In this case, the electronic device 1 may include the multiple phase control units 23 and the multiple amplifiers 24 to correspond to the multiple transmission antennas 25. Each of the multiple phase control units 23 may control the phase of a respective one of the multiple transmission waves supplied from the synthesizer 22 and to be transmitted from the respective transmission antennas 25. Each of the multiple amplifiers 24 may amplify power of a respective one of the multiple transmission signals to be transmitted from the respective transmission antennas 25. In this case, the electronic device 1 may include the multiple transmission antennas. As described above, when the electronic device 1 illustrated FIG. 2 includes the multiple transmission antennas 25, the electronic device 1 may include multiple functional units necessary for transmitting the transmission waves T from the multiple transmission antennas 25.

The reception antenna 31 receives the reflected wave R. The reflected wave R may be the transmission wave T reflected off the predetermined object 200. The reception antenna 31 may include multiple antennas such as the reception antennas 31A to 31D, for example. Since the reception antennas 31 can be configured in a same manner as and/or similar manner to reception antennas for use in the known radar technology, more detailed description is omitted. The reception antenna 31 is connected to the LNA 32. A reception signal based on the reflected wave R received by the reception antenna 31 is supplied to the LNA 32.

In an embodiment, the electronic device 1 can receive, from each of the multiple reception antennas 31, the reflected wave R that is the transmission wave T that has been transmitted as the transmission signal (transmission chirp signal) such as a chirp signal, for example, and has been reflected off the predetermined object 200. When the transmission chirp signal is transmitted as the transmission wave T in this manner, the reception signal based on the received reflected wave R is referred to as a reception chirp signal. That is, the electronic device 1 receives the reception signal (for example, the reception chirp signal) as the reflected wave R from each of the reception antennas 31. When the electronic device 1 is installed on the stationary object 100, each of the reception antennas 31 may receive the reflected wave R from the outside of the stationary object 100 through a cover member such as a radar cover, for example. In this case, the radar cover may be made of a material, for example, a synthetic resin or rubber, that allows an electromagnetic wave to pass therethrough. This radar cover may also serve as a housing of the electronic device 1, for example. Covering the reception antennas 31 with a member such as the radar cover can reduce a risk of the reception antennas 31 being damaged or malfunctioning because of a contact with an external object. The radar cover and the housing may also be referred to as a radome.

When the reception antenna 31 is installed near the transmission antenna 25, these reception antenna 31 and transmission antenna 25 may be collectively included in the one electronic device 1. That is, for example, the one electronic device 1 may include at least one transmission antenna 25 and at least one reception antenna 31. For example, the one electronic device 1 may include multiple transmission antennas 25 and multiple reception antennas 31. In such a case, one radar sensor may be covered with a cover member such as one radar cover, for example.

The LNA 32 amplifies, with low noise, the reception signal based on the reflected wave R received by a respective one of the reception antennas 31. The LNA 32 may be a low-noise amplifier and amplifies, with low noise, the reception signal supplied from the reception antenna 31. The reception signal amplified by the LNA 32 is supplied to the mixer 33.

The mixer 33 mixes (multiplies) the reception signal having an RF frequency supplied from the LNA 32 and the transmission signal supplied from the synthesizer 22 to generate a beat signal. The beat signal obtained by the mixer 33 through mixing is supplied to the IF unit 34.

The IF unit 34 performs frequency conversion on the beat signal supplied from the mixer 33 to reduce the frequency of the beat signal to an intermediate frequency (IF). The beat signal whose frequency has been reduced by the IF unit 34 is supplied to the AD conversion unit 35.

The AD conversion unit 35 digitizes the analog beat signal supplied from the IF unit 34. The AD conversion unit 35 may be configured as any analog-to-digital conversion circuit (Analog-to-Digital Converter (ADC)). The digitized beat signal obtained by the AD conversion unit 35 is supplied to the distance FFT processing unit 11 of the controller 10. When the multiple reception units 30 are present, the beat signals each digitized by a respective one of the multiple AD conversion units 35 may be supplied to the distance FFT processing unit 11.

The distance FFT processing unit 11 of the controller 10 illustrated in FIG. 3 performs processing for estimating a distance between the stationary object 100 equipped with the electronic device 1 and the object 200, based on the beat signals supplied from the respective AD conversion units 35 of the reception units 30. The distance FFT processing unit 11 may include a processing unit that performs fast Fourier transform, for example. In this case, the distance FFT processing unit 11 may be configured as any circuit, any chip, or the like that performs fast Fourier transform (FFT). The distance FFT processing unit 11 may preform Fourier transform other than fast Fourier transform.

The distance FFT processing unit 11 performs FFT processing (hereinafter, appropriately referred to as “distance FFT processing”) on the beat signals that have been digitized by the respective AD conversion units 35. For example, the distance FFT processing unit 11 may perform FFT processing on complex signals supplied from the AD conversion units 35. The digitized beat signals obtained by the AD conversion units 35 can be represented as temporal changes in signal intensity (electric power). The distance FFT processing unit 11 performs FFT processing on such beat signals, so that the beat signals can be represented as a signal intensity (electric power) for each frequency. Through the distance FFT processing performed by the distance FFT processing unit 11, complex signals corresponding to the distance can be obtained based on the digitized beat signals obtained by the AD conversion units 35.

When a peak is equal to or greater than a predetermined threshold in a result obtained by the distance FFT processing, the distance FFT processing unit 11 may determine that the predetermined object 200 is present at a distance corresponding to the peak. For example, in a known method such as constant false alarm rate (CFAR)-based detection processing, an object (reflecting object) reflecting a transmission wave is determined to be present when a peak value that is equal to or greater than a threshold is detected from the average electric power or amplitude of a disturbance signal.

As described above, in an embodiment, the electronic device 1 can detect, as the target, the object 200 that reflects the transmission wave T, based on the transmission signal transmitted as the transmission wave T and the reception signal received as the reflected wave R. In an embodiment, the controller 10 of the electronic device 1 may perform the operation described above.

The distance FFT processing unit 11 can estimate a distance to a predetermined object, based on one chirp signal (for example, c1 illustrated in FIG. 3). That is, the electronic device 1 can measure (estimate) the distance L illustrated in FIG. 1 by performing the distance FFT processing. Since a technique for measuring (estimating) a distance to a predetermined object by performing FFT processing on a beat signal is known, more detailed description is appropriately simplified or omitted. The result (for example, distance information) of the distance FFT processing performed by the distance FFT processing unit 11 may be supplied to the velocity FFT processing unit 12. The result of the distance FFT processing performed by the distance FFT processing unit 11 may also be supplied to the determining unit 16, the angle-of-arrival estimating unit 17, the object detecting unit 18, and/or the like at the subsequent stage.

The velocity FFT processing unit 12 performs processing for estimating a relative velocity between the object 200 and the stationary object 100 equipped with the electronic device 1, based on the beat signal on which the distance FFT processing unit 11 has performed the distance FFT processing. The velocity FFT processing unit 12 may include a processing unit that performs fast Fourier transform, for example. In this case, the velocity FFT processing unit 12 may be configured as any circuit, any chip, or the like that performs fast Fourier transform (FFT). The velocity FFT processing unit 12 may preform Fourier transform other than fast Fourier transform.

The velocity FFT processing unit 12 further performs FFT processing (hereinafter, appropriately referred to as “velocity FFT processing”) on the beat signals on which the distance FFT processing unit 11 has performed the distance FFT processing. For example, the velocity FFT processing unit 12 may perform FFT processing on the complex signals supplied from the distance FFT processing unit 11. The velocity FFT processing unit 12 can estimate a relative velocity of the predetermined object, based on a subframe (for example, the subframe 1 illustrated in FIG. 3) including chirp signals. Through the velocity FFT processing performed on the multiple chirp signals by the velocity FFT processing unit 12, complex signals corresponding to the relative velocity can be obtained based on the complex signals corresponding to the distance obtained by the distance FFT processing unit 11.

When the distance FFT processing is performed on the beat signals in the above-described manner, multiple vectors can be generated. A relative velocity of the predetermined object can be estimated by determining a phase of a peak in a result of the velocity FFT processing performed on these multiple vectors. That is, the electronic device 1 can measure (estimate) a relative velocity between the predetermined object 200 and the stationary object 100 illustrated in FIG. 1 by performing the velocity FFT processing. Since a technique for measuring (estimating) a relative velocity of a predetermined object by performing velocity FFT processing on a result of distance FFT processing is known, more detailed description is appropriately simplified or omitted. The result (for example, velocity information) of the velocity FFT processing performed by the velocity FFT processing unit 12 may be supplied to the angle-of-arrival estimating unit 17. The result of the velocity FFT processing performed by the velocity FFT processing unit 12 may also be supplied to the determining unit 16, the object detecting unit 18, and/or the like at the subsequent stage.

When performing velocity FFT processing, the velocity FFT processing unit 12 may apply window control to avoid the occurrence of discontinuities. In such a case, the velocity FFT processing unit 12 may skip outputting a relative velocity adjacent to the relative velocity of the stationary object.

The difference calculating unit 13 stores, in the storage unit 14, the intensity of the complex signal corresponding to the distance, from the electronic device 1, of the object reflecting the transmission wave. In particular, the difference calculating unit 13 may store, in the storage unit 14, the signal intensity corresponding to the distance of the area where the relative velocity with respect to the electronic device 1 is zero (that is, the area of a stationary object). The signal intensity may indicate the electric power or amplitude of the reception signal. The difference calculating unit 13 may store, in the storage unit 14, a distribution of the signal intensity corresponding to the distance of the area of the stationary object when the difference calculating unit 13 calculates a difference between signal intensities as described later.

The storage unit 14 may store a program executed by the controller 10 or the functional units of the controller 10, results of processing performed by the controller 10, and so on. The storage unit 14 may function as a work memory of the controller 10. The storage unit 14 can be implemented by, but not limited to, a semiconductor memory or a magnetic disk, for example, and may be implemented by any storage device. The storage unit 14 may be, for example, a storage medium such as a memory card inserted to the electronic device 1 according to the present embodiment. The storage unit 14 may be an internal memory of the CPU used as the controller 10 as described above. The storage unit 14 may also function as the any storage unit described above.

The difference calculating unit 13 may average the signal intensities (electric powers or amplitudes), stored in the storage unit 14, corresponding to the distance of the area of the stationary object in two or more different time slots.

As described above, the distance FFT processing unit 11 and the velocity FFT processing unit 12 perform the distance FFT processing and the velocity FFT processing in the above-described manner on a beat signal received in the frame of the transmission wave. The difference calculating unit 13 calculates a difference between the distribution of the signal intensity (electric power or amplitude) corresponding to the distance of the stationary object and the distribution of the signal intensity corresponding to the distance for the relative velocity of the stationary object stored in the storage unit 14. The signal intensity corresponding to the distance of the stationary object may be the intensity of the complex signal corresponding to the distance, from the electronic device, to the object reflecting the transmission wave, and may be, for example, the intensity of the complex signal based on the most recently received reflected wave. The signal intensity corresponding to the distance for the relative velocity of the stationary object stored in the storage unit 14 may be the intensity of the complex signal detected at an earlier time, and may be the intensity of the complex signal stored in the storage unit 14. That is, the difference calculating unit 13 may calculate a difference between the intensity of the complex signal corresponding to the distance from the electronic device 1 to the object and the intensity of the complex signal detected at an earlier time than this complex signal. The complex signal corresponding to the distance from the electronic device 1 to the object may be a signal (reception signal) based on the most recently received reflected wave. In particular, the difference calculating unit 13 may convert the intensities of these complex signals into logarithmic values, and then calculate a difference between the logarithmic values. For example, the difference calculating unit 13 may calculate a difference between values representing the intensities of the above-described complex signals in decibels (dB). The difference calculating unit 13 may divide the intensities of these complex signals by a reference signal intensity, convert values obtained by the division into logarithmic values, and calculate a difference between the logarithmic values. For example, the difference calculating unit 13 may calculate a difference between values representing the intensities of the above-described complex signals in decibels (dB). The difference calculating unit 13 may divide the intensities of these complex signals by an intensity of a transmitted signal, convert values obtained by the division into logarithmic values, and calculate a difference between the logarithmic values. For example, the difference calculating unit 13 may calculate a difference between values representing the intensities of the above-described complex signals in decibels (dB).

On the other hand, the difference calculating unit 13 may skip calculating the difference for the signal intensity corresponding to the distance of the area where the relative velocity with respect to the electronic device 1 is not zero (that is, an area not for the stationary object). The signal intensity of the complex signal corresponding to the distance used in calculating the difference may be smoothed using a moving average over two or more different time slots, for example, a moving average across frames of the transmission wave. The difference calculating unit 13 may skip calculating the difference for the signal intensity corresponding to the distance of an area where the relative velocity with respect to the electronic device 1 is not equal to or less than a predetermined percentage (appropriately settable such as 1%, 3%, or 10%, for example) with respect to the velocity of the electronic device 1 (that is, an area not for the stationary object). The signal intensity of the complex signal corresponding to the distance used in calculating the difference may be smoothed using a moving average over two or more different time slots, for example, a moving average across frames of the transmission wave.

The update processing unit 15 updates difference data used by the difference calculating unit 13 as occasion arises. For example, when a correlation value of pieces of difference data acquired at two or more different times in the difference data stored in the storage unit 14 is equal to or greater than a threshold, the update processing unit 15 may determine that there is no environmental change of the stationary object and update the difference data. When updating the difference data, the update processing unit 15 may acquire data while changing the time several times and adopt data free from a change.

The determining unit 16 performs determination processing for a distance and/or a relative velocity, based on the result of the distance FFT processing performed by the distance FFT processing unit 11 and/or the result of the velocity FFT processing performed by the velocity FFT processing unit 12. The determining unit 16 determines whether an object is detected at a predetermined distance and/or a predetermined relative velocity. The determination performed by the determining unit 16 is further described below.

In a common FM-CW radar technology, whether a target is present can be determined based on a result of fast Fourier transform processing or the like performed on a beat frequency extracted from a reception signal. The result of the fast Fourier transform processing or the like performed on the beat frequency extracted from the reception signal includes a noise component due to clutter (extraneous reflection component) or the like. Thus, processing for removing the noise component from the processing result of the reception signal and extracting a target signal alone may be performed.

Methods for determining whether the target is present include a scheme (threshold detection scheme) in which a threshold is set for the output of the reception signal and the target is determined to be present when the intensity of a reflected signal exceeds the threshold. When this scheme is employed, clutter having a signal intensity exceeding the threshold is also determined as the target. Consequently, a so-called “false alarm” is issued. Whether the signal intensity of this clutter exceeds the threshold is a matter of a probability. The probability of the signal intensity of this clutter exceeding the threshold is called “a probability of false alarm”. As a method for suppressing this probability of false alarm to be low and constant, a constant false alarm rate can be used.

Hereinafter, the constant false alarm rate is also simply referred to as CFAR. CFAR uses an assumption that the signal intensity (amplitude) of noise conforms to a Rayleigh distribution. Based on this assumption, when a weight for calculating a threshold for use in determining whether a target is detected is fixed, an error rate of target detection becomes theoretically constant regardless of the amplitude of noise.

A scheme called Cell-Averaging CFAR (hereinafter, also referred to as CA-CFAR) is known CFAR in the common radar technology. In CA-CFAR, a signal intensity value (for example, an amplitude value) of the reception signal having undergone predetermined processing may be sequentially input to a shift register at a constant sampling frequency. This shift register includes a cell under test at the center thereof and includes multiple reference cells on both sides of the cell under test. Every time the signal intensity value is input to the shift register, each signal intensity value input earlier is moved from a cell on one end side (for example, a left end side) to a cell on the other end side (for example, a right end side) of the shift register by one. In synchronization with the input timing, the values in the reference cells are averaged. The average value thus obtained is multiplied by a prescribed weight, and the result is calculated as a threshold. When the value in the cell under test is greater than the threshold thus calculated, the value in the cell under test is output. On the other hand, when the value in the cell under test is not greater than the calculated threshold, a value of 0 (zero) is output. As described above, in CA-CFAR, the threshold is calculated from the average value of the values in the reference cells, and whether the target is present is determined. In this manner, a detection result can be obtained.

In CA-CFAR, for example, when multiple targets are present in the vicinity to each other, the threshold calculated in the vicinity of the targets increases because of the nature of the algorithm. Thus, a target may not be detected regardless of the target having a sufficient signal intensity. Likewise, when there is a clutter step, the calculated threshold increases also in the vicinity of the clutter step. In this case, a small target located in the vicinity of the clutter step may not be detected.

In relation to CA-CFAR described above, there is a technique called Order Statistic CFAR (hereinafter, also referred to as OS-CFAR) as a technique for obtaining a threshold from the median of the values in the reference cells or from a value at a prescribed place in order of the values in the reference cells sorted in ascending order. OS-CFAR is a method in which a threshold is set based on ordered statistics and a target is determined to be present when the signal intensity exceeds the threshold. This OS-CFAR can deal with the above-described issues in CA-CFAR. OS-CFAR can be implemented by performing processing that is partially different from the processing of CA-CFAR. In the description below, the electronic device 1 in an embodiment performs the OS-CFAR processing.

The determining unit 16 may use OS-CFAR to determine whether an object is detected. In this case, the determining unit 16 may use different thresholds for an area of a stationary object and an area of a non-stationary object to perform the determination. The determining unit 16 may skip detecting an area of the relative velocity adjacent to the stationary object when the above-described window control is applied. The determining unit 16 may use an area of a different distance at the same relative velocity, as an area of noise used in OS-CFAR.

The angle-of-arrival estimating unit 17 estimates a direction (angle of arrival) from which the reflected wave R arrives from the predetermined object 200, based on a result of the determination performed by the determining unit 16. The angle-of-arrival estimating unit 17 may estimate the angle of arrival for a point determined to meet the threshold by the determining unit 16. The electronic device 1 can estimate the direction from which the reflected wave R arrives, by receiving the reflected wave R from the multiple reception antennas 31. For example, the multiple reception antennas 31 are arranged at a predetermined interval. In this case, the transmission wave T transmitted from the transmission antenna 25 is reflected off the predetermined object 200 to become the reflected wave R. Each of the multiple reception antennas 31 arranged at the predetermined interval receives the reflected wave R. The angle-of-arrival estimating unit 17 can estimate the direction from which the reflected wave R arrives at each of the multiple reception antennas 31, based on the phase of the reflected wave R received by the reception antenna 31 and a difference in path of the reflected wave R. That is, the electronic device 1 can measure (estimate) the angle of arrival θ illustrated in FIG. 1, based on the result of the velocity FFT processing.

Various techniques for estimating a direction from which the reflected wave R arrives, based on a result of velocity FFT processing have been proposed. For example, known direction-of-arrival estimation algorithms include MUSIC (MUltiple SIgnal Classification), ESPRIT (Estimation of Signal Parameters via Rotational Invariance Technique), and the like. Thus, more detailed description of the known techniques is appropriately simplified or omitted. Information (angle information) on the angle of arrival θ estimated by the angle-of-arrival estimating unit 17 may be supplied to the object detecting unit 18.

The object detecting unit 18 detects an object located in a range to which the transmission wave T is transmitted, based on the information supplied from at least any of the distance FFT processing unit 11, the velocity FFT processing unit 12, or the angle-of-arrival estimating unit 17. The object detecting unit 18 may perform detection of an object by performing, for example, clustering processing based on the supplied distance information, velocity information, and angle information. For example, DBSCAN (Density-based spatial clustering of applications with noise) or the like is a known algorithm used in clustering of data. In the clustering processing, for example, average electric power of points constituting the detected object may be calculated. The distance information, the velocity information, the angle information, and the electric power information of the object detected by the object detecting unit 18 may be supplied to another device, for example. The object detecting unit 18 may calculate average electric power of a point cloud representing the object.

The electronic device 1 illustrated in FIG. 2 includes the two transmission antennas 25 and the four reception antennas 31. However, in an embodiment, the electronic device 1 may include any number of transmission antennas 25 and any number of reception antennas 31. For example, the electronic device 1 including the two transmission antennas 25 and the four reception antennas 31 can be considered to include a virtual antenna array virtually including eight antennas. As described above, the electronic device 1 may receive the reflected wave R of 16 subframes illustrated in FIG. 4 by using, for example, the eight virtual antennas.

An operation of the electronic device 1 in an embodiment is described.

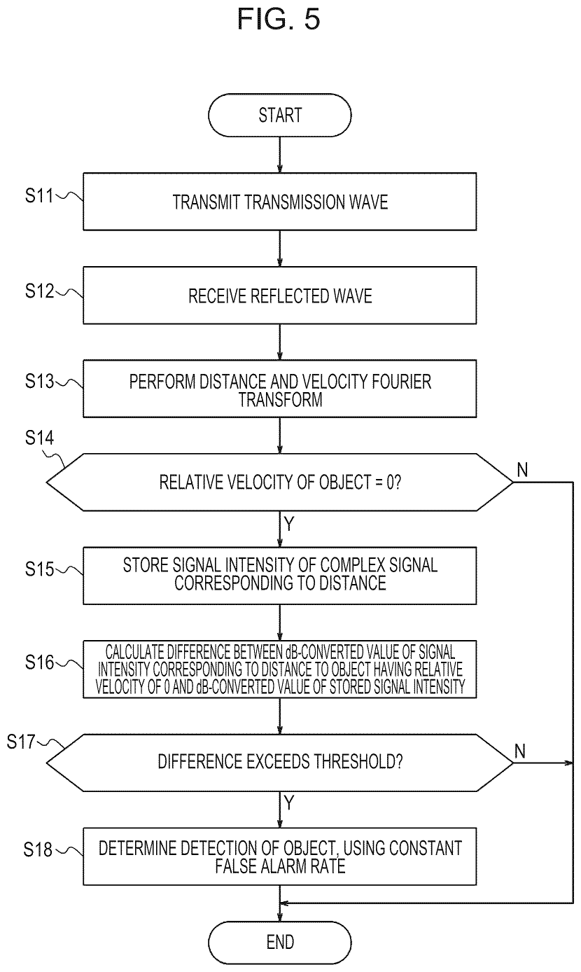

FIG. 5 is a flowchart for describing an operation performed by the electronic device 1. A flow of the operation performed by the electronic device 1 is briefly described below. The operation illustrated in FIG. 5 may be started, for example, when the electronic device 1 attached to the stationary object 100 attempts to detect an object located around the stationary object 100.

After the process illustrated FIG. 5 is started, the controller 10 performs control so that a transmission wave is transmitted from the transmission antenna 25 of the electronic device 1 (step S11).

After the transmission wave is transmitted in step S11, the controller 10 performs control so that a reflected wave that is the transmission wave reflected off an object is received from the reception antenna 31 of the electronic device 1 (step S12).

After the reflected wave is received in step S12, the controller 10 performs the distance FFT processing and the velocity FFT processing on a beat signal based on the transmission wave and the reflected wave (step S13). In step S13, the distance FFT processing unit 11 may perform the distance FFT processing, and the velocity FFT processing unit 12 may perform the velocity FFT processing.

After the distance FFT processing and the velocity FFT processing are performed in step S3, the difference calculating unit 13 determines whether the relative velocity of the object with respect to the electronic device 1 is zero (step S14). When the relative velocity is not zero in step S14, the process illustrated in FIG. 5 may end. When the relative velocity is not zero in step S14, whether an object is detected may be determined using a threshold different from that used for a stationary object, as described above.

When the relative velocity is zero in step S14, the difference calculating unit 13 stores a signal intensity (electric power or amplitude) of a complex signal corresponding to the distance in the storage unit 14 (step S15).

After the signal intensity of the complex signal corresponding to the distance is stored in step S15, the difference calculating unit 13 performs processing of step S16. In step S16, the difference calculating unit 13 calculates a difference between a result obtained by converting the signal intensity corresponding to the distance of the stationary object, that is, the object whose relative velocity is zero, into a logarithmic value (for example, decibels) and a result obtained by converting the signal intensity stored in the storage unit 14 into a logarithmic value (for example, decibels). The signal intensity stored in the storage unit 14 may be a signal intensity of a complex signal detected at an earlier time. The complex signal detected at the earlier time may be a complex signal detected at any time earlier than a time when the reflected wave is most recently received. For example, the complex signal detected at the earlier time may be a complex signal detected at a time earlier than a current time by several seconds, several minutes, several hours, several days, or several weeks.

After the difference is calculated in step S16, the determining unit 16 determines whether the difference exceeds a predetermined threshold (step S17). When the difference does not exceed the threshold in step 17, the controller 10 may end the operation illustrated in FIG. 5. In this case, detection of an object using OS-CFAR may be skipped for the difference that does not exceed the threshold.

When the difference exceeds the threshold in step 17, the angle-of-arrival estimating unit 17 may estimate the direction from which the reflected wave arrives from the object. When the difference exceeds the thresholds in step 17, the object detecting unit 18 may perform detection of an object using OS-CFAR (step S18). The operation illustrated in FIG. 5 may be performed repeatedly, for example, at predetermined timings or irregularly.

As described above the controller 10 may calculate the difference between the logarithmic value of the intensity of the complex signal corresponding to the distance, from the electronic device 1, of the object reflecting the transmission wave and the logarithmic value of the intensity of the complex signal detected at the earlier time. The controller 10 may detect an object using the constant false alarm rate, based on the difference calculated as described above. Hereinafter, the intensity of the complex signal corresponding to the distance, from the electronic device, of the object reflecting the transmission wave is referred to as a first signal intensity for convenience. The first signal intensity may be, for example, an intensity of a complex signal based on a most recently received reflected wave. The intensity of the complex signal detected at an earlier time than the first signal intensity is referred to as a second signal intensity for convenience. The second signal intensity may be, for example, an intensity of a complex signal stored in the storage unit 14. That is, the controller 10 may detect an object using the constant false alarm rate, based on a difference between a logarithmic value of the first signal intensity and a logarithmic value of the second signal intensity. In particular, the controller 10 may detect the object using the constant false alarm rate, based on a difference between a value representing the first signal intensity in decibels (dB) and a value representing the second signal intensity in decibels (dB). When the relative velocity of the object reflecting the transmission wave with respect to the electronic device 1 is zero, the controller 10 may detect the object using the constant false alarm rate, based on the difference between the logarithmic value of the first signal intensity and the logarithmic value of the second signal intensity.

The controller 10 may store, as the second signal intensity, in the storage unit 14, the intensity of the complex signal detected at the earlier time than the first signal intensity. In this case, the controller 10 may detect the object using the constant false alarm rate, based on a difference between the logarithmic value of the first signal intensity and a logarithmic value of the intensity of the complex signal stored as the second signal intensity in the storage unit 14. The controller 10 may detect the object using the constant false alarm rate when the difference between the logarithmic value of the first signal intensity and the logarithmic value of the second signal intensity exceeds a predetermined threshold. The controller 10 may detect the object using the constant false alarm rate, with reference to different thresholds for an object whose relative velocity with respect to the electronic device 1 is zero and an object whose relative velocity with respect to the electronic device 1 is not zero, the different thresholds serving as the predetermined threshold.

In an embodiment, the electronic device 1 calculates a difference between the logarithmic value of the first signal intensity and the logarithmic value of the second signal intensity detected at a time earlier than a time when the first signal intensity is detected. In an embodiment, the electronic device 1 detects an object using the constant false alarm rate, based on the difference described above. In an embodiment, the electronic device 1 can detect an object with good accuracy by appropriately setting a threshold (CFAR threshold) for object detection using the constant false alarm rate. For example, in an embodiment, when the difference between the logarithmic value of the first signal intensity and the logarithmic value of the second signal intensity is relatively large, the electronic device 1 may set the threshold such that an object is to be detected using the constant false alarm rate. On the other hand, in an embodiment, when the difference between the logarithmic value of the first signal intensity and the logarithmic value of the second signal intensity is relatively small, the electronic device 1 may set the threshold such that an object is not detected using an alarm rate.

In this manner, in an embodiment, the electronic device 1 can determine that an object, which is a generation source of the first signal intensity and is not present when the second signal intensity is acquired, is an object that has not been present. In an embodiment, the electronic device 1 can determine that an object, which is a generation source of the first signal intensity and is also present when the second signal intensity is acquired, is an object that has been present. Thus, in an embodiment, the electronic device 1 can distinguishably detect a stationary object that is not present normally (that is, a stationary object that is temporarily present) from a stationary object that has been present. Therefore, in an embodiment, the electronic device 1 can detect an object with good accuracy.

Hereinafter, effects of the operation of the electronic device 1 in an embodiment will be described by comparison with a sensor of a millimeter-wave radar assumed in the related art.

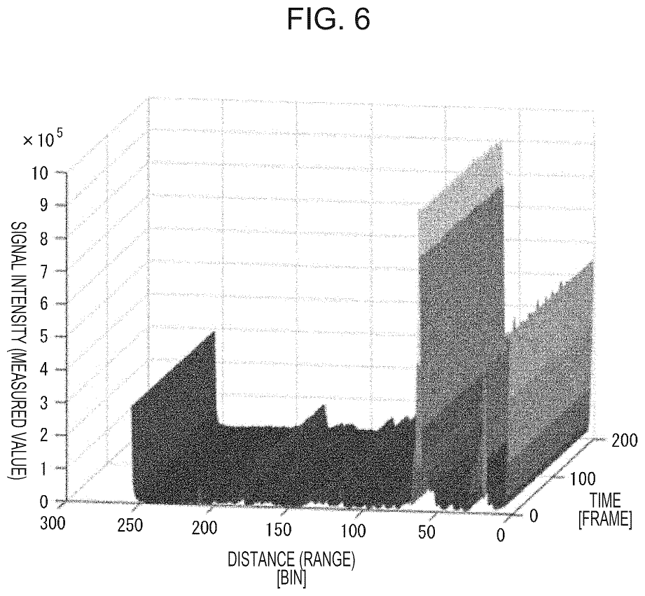

FIGS. 6 to 9 are graphs illustrating processing of a signal detected by a sensor of a millimeter-wave radar assumed in the related art, as a comparative example for describing the processing performed by the electronic device 1 in an embodiment.

FIG. 6 is a graph illustrating an example of the first signal intensity detected by a sensor of a millimeter-wave radar assumed in the related art. That is, FIG. 6 is a graph illustrating an example of the intensity of the complex signal corresponding to the distance, from the electronic device 1, of the object reflecting the transmission wave. FIG. 6 may illustrate a temporal change in the intensity of the complex signal corresponding to the distance detected based on the reflected wave received by the electronic device 1 in, for example, a most recent predetermined time (for example, 10 seconds).

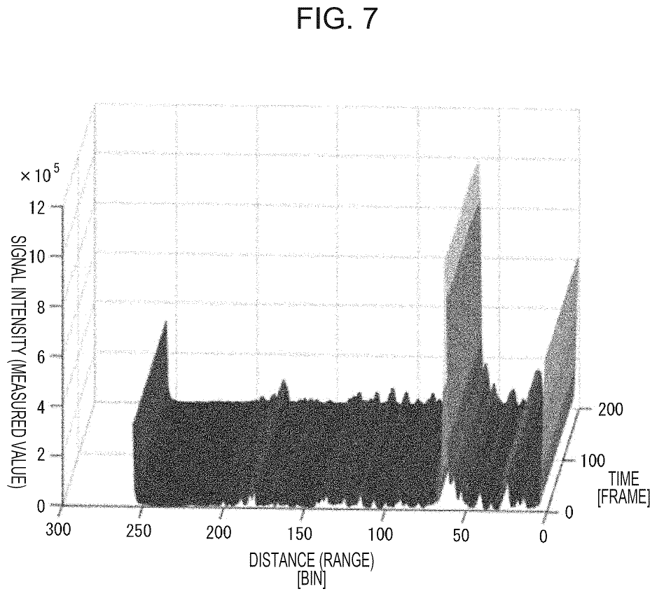

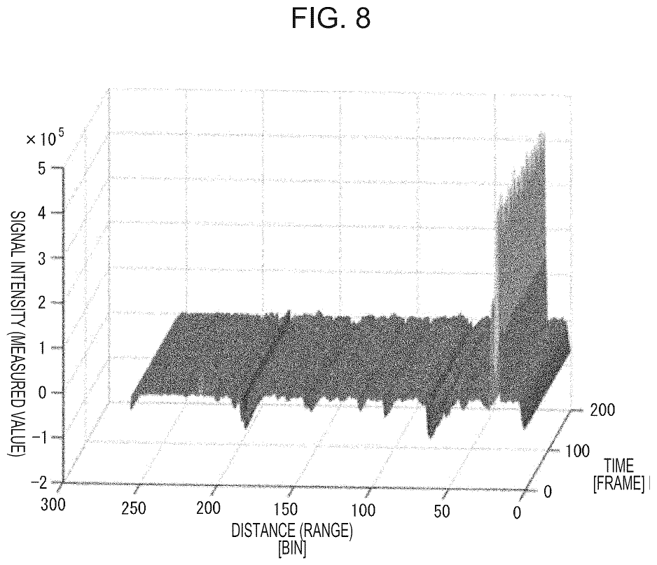

In the graph illustrated in FIG. 6, an axis in a depth direction represents time. The unit of time may be the unit of frames of a transmission wave by the electronic device 1. For example, when the electronic device 1 transmits a transmission wave of 20 frames per second, the axis in the depth direction illustrated in FIG. 6 may represent a time from 0 seconds to 10 seconds. In the graph illustrated in FIG. 6, an axis in a horizontal direction represents a distance (range). The unit of the distance (range) may be the unit of bin in the electronic device 1. For example, the bin in the horizontal direction illustrated in FIG. 6 may be such that a resolution of 1 bin in the electronic device 1 corresponds to 0.6 m. That is, when the resolution of 1 bin is 0.6 m, for the bin in the horizontal direction illustrated in FIG. 6, eight samples may be present at 0.6 m, 1.2 m, 1.8 m, 2.4 m, 3.0 m, 3.6 m, 4.2 m, and 4.8 m in a distance from 0 m to 5 m, for example. In the graph illustrated in FIG. 6, an axis in a vertical direction may represent a value measured as the signal intensity. In the graph illustrated in FIG. 6, for the axis in the vertical direction, an arbitrary unit [a.u.] of the signal intensity may be employed. The same applies to FIGS. 7 and 8 described below.

FIG. 7 is a graph illustrating an example of the second signal intensity stored in the storage unit 14. That is, FIG. 7 is a graph illustrating an example of the intensity of the complex signal detected at an earlier time than the first signal intensity. As described above, the electronic device 1 is stationary. That is, both of the signal intensity illustrated in FIG. 6 and the signal intensity illustrated in FIG. 7 may be examples of signal intensities detected at the same position (place) but at different times. FIG. 7 may illustrate a temporal change in the intensity of the complex signal corresponding to the distance detected based on the reflected wave received by the electronic device 1 in, for example, a predetermined time (for example, 10 seconds) earlier than that for the first signal intensity. A physical quantity represented by each axis of the graph illustrated in FIG. 7 may be the same as or similar to that in FIG. 6. The vertical axes of the graphs illustrated in FIGS. 6 and 7 both represent a measured (detected) signal intensity as it is.

FIG. 8 is a graph illustrating a result obtained by subtracting the signal intensity illustrated in FIG. 7 from the signal intensity illustrated in FIG. 6. That is, FIG. 8 is a graph illustrating a calculated result of a difference between the signal intensity (first signal intensity) illustrated in FIG. 6 and the signal intensity (second signal intensity) illustrated in FIG. 7. This calculation of the difference corresponds to the processing illustrated in step S16 in FIG. 5. Note that the difference is calculated between the values of the signal intensities that have not converted into values in decibels (dB).

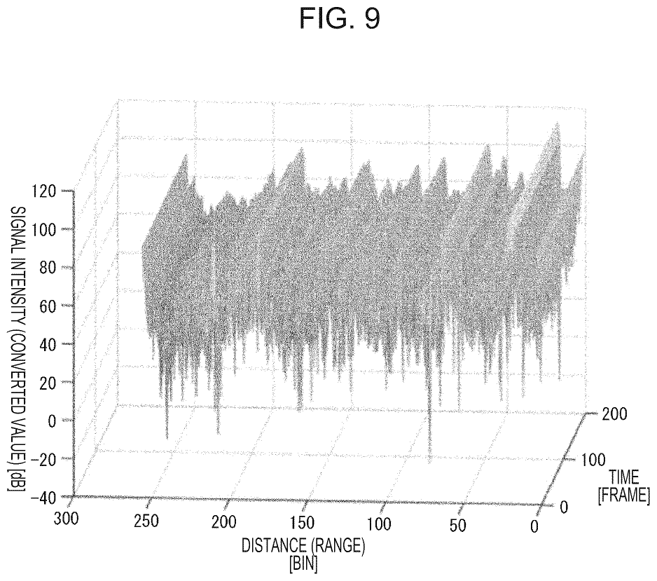

FIG. 9 is a graph illustrating a result obtained by converting the difference between the signal intensities illustrated in FIG. 8 from the complex signal to a logarithmic value. That is, in the graph illustrated in FIG. 8, the axis in the vertical direction represents the difference between the signal intensities of the measured (detected) complex signals. In contrast, in the graph illustrated in FIG. 9, the axis in the vertical direction may represent, in decibels, the difference between the signal intensities of the complex signals. As illustrated in FIG. 9, in the result obtained by converting the difference in between the signal intensities from the complex signal to the logarithmic value, several peaks appear in the distance direction. However, many of such peaks may be caused by noise or the like. Therefore, when an object is detected using the constant false alarm ratio, based on the graph illustrated in FIG. 9, false detection is likely to occur. This is because when the difference between the signal intensities of the measured (detected) complex signals is converted into decibels, even a small difference can become a difference of a large value after the return to decibels.

Therefore, in an embodiment, the electronic device 1 calculates the difference after converting the signal intensities of the measured (detected) complex signals into values in decibels, instead of converting the difference between the signal intensities of the measured (detected) complex signals into decibels.

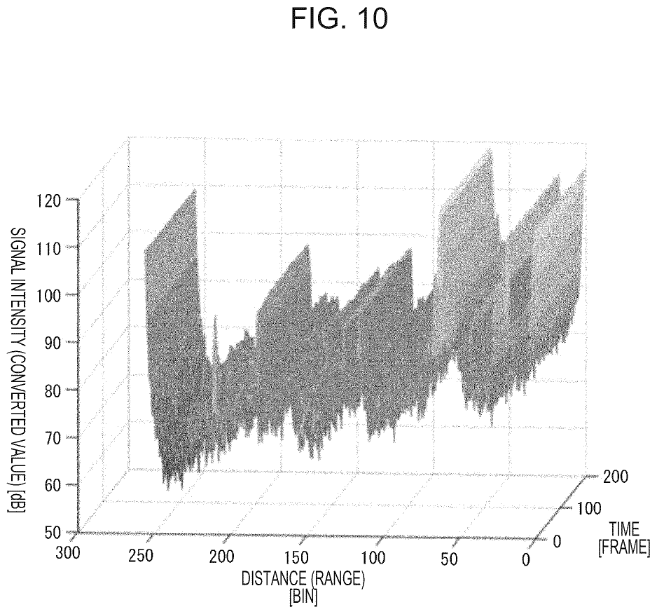

FIGS. 10 to 12 are graphs illustrating the processing performed by the electronic device 1 in an embodiment.

FIG. 10 is a graph illustrating an example of a decibel value to which the first signal intensity detected by the electronic device 1 is converted in an embodiment. That is, FIG. 10 is a graph illustrating an example of a decibel value to which the intensity of the complex signal corresponding to the distance, from the electronic device 1, of the object reflecting the transmission wave is converted. FIG. 10 may illustrate a result obtained by converting, into a decibel value, a temporal change in the intensity of the complex signal corresponding to the distance detected based on the reflected wave received by the electronic device 1 in, for example, a most recent predetermined time (for example, 10 seconds). For example, the graph of the first signal intensity illustrated in FIG. 10 may illustrate the signal intensity in decibels obtained by converting the graph of the first signal intensity illustrated in FIG. 6.

A physical quantity represented by each axis of the graph illustrated in FIG. 10 may be the same as or similar to that in FIG. 6. However, while the vertical axis of the graph illustrated in FIG. 6 represents the measured (detected) signal intensity as described above, the vertical axis of the graph illustrated in FIG. 10 represents signal intensity in decibels to which the measured (detected) signal intensity is converted.

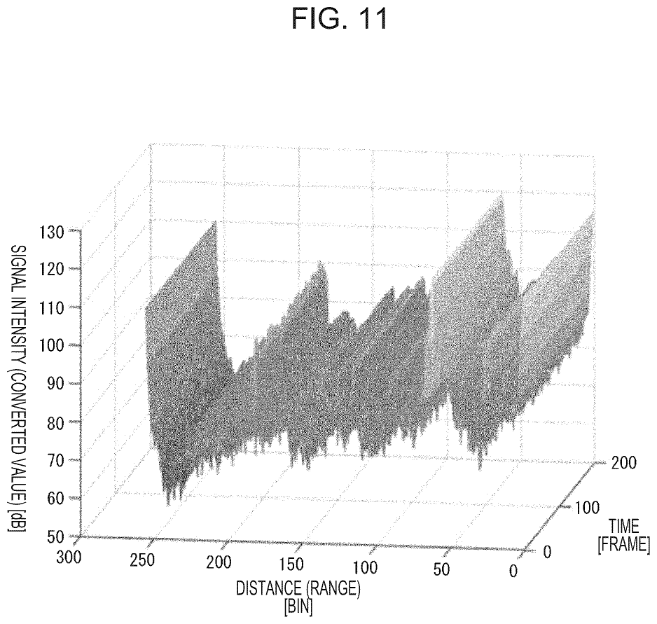

FIG. 11 is a diagram illustrating an example of a decibel value to which the second signal intensity stored in the storage unit 14 is converted. That is, FIG. 11 is a graph illustrating an example of a decibel value to which the intensity of the complex signal detected at an earlier time than the first signal intensity is converted. FIG. 11 may illustrate a result obtained by converting, into a decibel value, a temporal change in the intensity of the complex signal corresponding to the distance detected based on the reflected wave received by the electronic device 1 in a predetermined time (for example, 10 seconds) earlier than that for the first signal intensity. For example, the graph of the second signal intensity illustrated in FIG. 11 may illustrate the signal intensity in decibels obtained by converting the graph of the second signal intensity illustrated in FIG. 7.

A physical quantity represented by each axis of the graph illustrated in FIG. 11 may be the same as or similar to that in FIG. 7. However, while the vertical axis of the graph illustrated in FIG. 7 represents the measured (detected) signal intensity as described above, the vertical axis of the graph illustrated in FIG. 11 represents the signal intensity in decibels to which the measured (detected) signal intensity is converted.

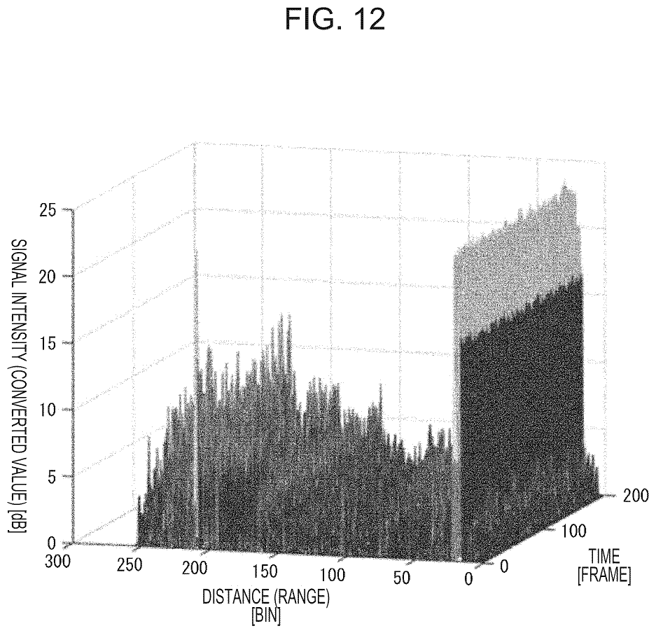

FIG. 12 is a graph illustrating a result obtained by subtracting the decibel-converted signal intensity illustrated in FIG. 10 from the decibel-converted signal intensity illustrated in FIG. 11. That is, FIG. 12 is a graph illustrating a calculated result of a difference between the decibel-converted signal intensity (first signal intensity) illustrated in FIG. 10 and the decibel-converted signal intensity (second signal intensity) illustrated in FIG. 11. This calculation of the difference corresponds to the processing illustrated in step S16 in FIG. 5.

As illustrated in FIG. 12, in a result obtained by determining a difference between the logarithmic values to which the signal intensities of the complex signals are converted, a significant peak appears at a position where an object is actually present in the distance direction (around a distance of 20 bins). As described above, in an embodiment, the electronic device 1 determines a difference between pieces of data also in an area where a peak is originally high, so that an error may be absorbed to some extent. Therefore, when an object is detected using the constant false alarm ratio, based on the graph illustrated in FIG. 12, the object to be detected can be detected with good accuracy.

In an embodiment, the electronic device 1 may smooth the signal intensity with respect to time as appropriate in the process of performing signal processing on the complex signal. For example, in an embodiment, in the electronic device 1, the controller 10 may perform smoothing at an appropriate time on the difference in signal intensity illustrated in FIG. 12. For example, the controller 10 may calculate an average of data of the difference in signal intensity illustrated in FIG. 12, over a time for several frames.

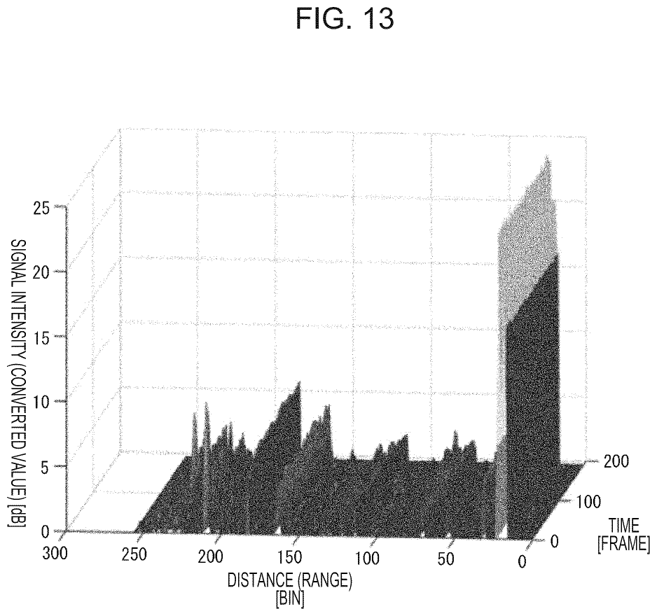

FIG. 13 is a graph illustrating an example of a result obtained by calculating an average of the data of the difference in signal intensity illustrated in FIG. 12, over a time for several frames. As illustrated in the graph of FIG. 13, unstable peaks can be reduced by averaging the data of the difference for several frames (time). Therefore, in an embodiment, the electronic device 1 can emphasize a peak at a position where an object is actually present in the distance direction.

In an embodiment, the electronic device 1 may smooth each of the logarithmic value of the first signal intensity illustrated in FIG. 10 and the logarithmic value of the second signal intensity illustrated in FIG. 11 over an appropriate time, for example. That is, in an embodiment, the controller 10 may detect an object using the constant false alarm rate, based on a difference between a result obtained by smoothing the logarithmic value of the first signal intensity with respect to time and a result obtained by smoothing the logarithmic value of the second signal intensity with respect to time.

While the present disclosure has been described based on the various drawings and embodiments, it is to be noted that a person skilled in the art can easily make various variations or corrections based on the present disclosure. Therefore, it is to be noted that these variations or corrections are within the scope of the present disclosure. For example, functions and the like included in each functional unit can be rearranged without causing any logical contradiction. Multiple functional units or the like may be combined into one or may be divided. The embodiments according to the present disclosure described above are not limited to strict implementation according to the respective embodiments described above, and may be implemented by appropriately combining the features or omitting part thereof. That is, a person skilled in the art can make various variations and corrections to the contents of the present disclosure based on the present disclosure. Therefore, these variations and corrections are within the scope of the present disclosure. For example, in each embodiment, each functional unit, each means, each step, or the like can be added to another embodiment or replaced with each functional unit, each means, each step, or the like in another embodiment without causing any logical contradiction. In each embodiment, multiple functional units, means, steps, or the like may be combined into one or may be divided. The embodiments of the present disclosure described above are not limited to strict implementation according to the respective embodiments described above, and may be implemented by appropriately combining the features or omitting part thereof.

The embodiments described above are not limited only to implementation as the electronic device 1. For example, the embodiments described above may be implemented as a method for controlling a device such as the electronic device 1. For example, the embodiments described above may be implemented as a program to be executed by a device such as the electronic device 1 or a computer, or may be implemented as a storage medium or a recording medium in which such a program is recorded.

### REFERENCE SIGNS

1 electronic device
10 controller
11 distance FFT processing unit
12 velocity FFT processing unit
13 difference calculating unit
14 storage unit
15 update processing unit
16 determining unit
17 angle-of-arrival estimating unit
18 object detecting unit
20 transmission unit
21 signal generating unit
22 synthesizer
23 phase control unit
24 amplifier
25 transmission antenna
30 reception unit
31 reception antenna
32 LNA
33 mixer
34 IF unit
35 AD conversion unit

1. An electronic device comprising:
a controller configured to detect an object, based on a transmission signal transmitted as a transmission wave and a reception signal received as a reflected wave that is the transmission wave having been reflected off the object, wherein
the controller is configured to detect the object, based on a difference between a logarithmic value of a first signal intensity of a first signal and a logarithmic value of a second signal intensity of a second signal,
the first signal intensity corresponding to a distance of the object from the electronic device, the first signal being calculated based on a first transmission signal transmitted at a first time and a first reception signal received as the reflected wave of the first transmission signal,
the second signal intensity corresponding to the distance of the object from the electronic device, the second signal being calculated based on a second transmission signal transmitted at a second time earlier than the first time and a second reception signal received as the reflected wave of the second transmission signal.

2. The electronic device according to claim 1, wherein the controller is configured to detect the object using a constant false alarm rate, based on a difference between a logarithmic value of a first signal intensity of a complex signal calculated based on the transmission signal and the reception signal and a logarithmic value of a second signal intensity of the complex signal calculated based on the transmission signal and the reception signal, the first signal intensity corresponding to the distance of the object from the electronic device, the second signal intensity being detected at an earlier time than the first signal intensity.

3. The electronic device according to claim 1, wherein the controller is configured to detect the object using a constant false alarm rate, based on a difference between a value representing the first signal intensity in decibels and a value representing the second signal intensity in decibels.

4. The electronic device according to claim 1, wherein the controller is configured to detect the object using a constant false alarm rate, based on a difference between the logarithmic value of the first signal intensity and the logarithmic value of the second signal intensity when a relative velocity of the object with respect to the electronic device is zero.

5. The electronic device according to claim 1, wherein the controller is configured to detect the object using a constant false alarm rate, based on a difference between a result obtained by smoothing the logarithmic value of the first signal intensity with respect to time and a result obtained by smoothing the logarithmic value of the second signal intensity with respect to time.

6. The electronic device according to claim 1, wherein the controller is configured to store, as the second signal intensity, in a storage unit, an intensity of a complex signal detected at an earlier time than the first signal intensity.

7. The electronic device according to claim 6, wherein the controller is configured to detect the object using a constant false alarm rate, based on a difference between the logarithmic value of the first signal intensity and a logarithmic value of the intensity of the complex signal stored as the second signal intensity in the storage unit.

8. The electronic device according to claim 1, wherein the controller is configured to detect the object using a constant false alarm rate when the difference between the logarithmic value of the first signal intensity and the logarithmic value of the second signal intensity exceeds a predetermined threshold.

9. The electronic device according to claim 8, wherein the controller is configured to detect the object using the constant false alarm rate, with reference to different thresholds for an object whose relative velocity with respect to the electronic device is zero and an object whose relative velocity with respect to the electronic device is not zero, the different thresholds serving as the predetermined threshold.

10. A method for controlling an electronic device that detects an object, based on a transmission signal transmitted as a transmission wave and a reception signal received as a reflected wave that is the transmission wave having been reflected off the object, the method comprising:
detecting the object, based on a difference between a logarithmic value of a first signal intensity of a first signal and a logarithmic value of a second signal intensity of a second signal,
the first signal intensity of the first signal corresponding to a distance of the object from the electronic device, the first signal being calculated based on a first transmission signal transmitted at a first time and a first reception signal received as the reflected wave of the first transmission signal,
the second signal intensity of the second signal corresponding to the distance of the object from the electronic device, the second signal being calculated based on a second transmission signal transmitted at a second time earlier than the first time and a second reception signal received as the reflected wave of the second transmission signal.

11. A non-transitory computer-readable recording medium storing computer program instructions, which when executed by an electric device to detect an object, based on a transmission signal transmitted as a transmission wave and a reception signal received as a reflected wave that is the transmission wave having been reflected off the object, cause the electronic device to:
detect the object, based on a difference between a logarithmic value of a first signal intensity of a first signal and a logarithmic value of a second signal intensity of a second signal,
the first signal intensity corresponding to a distance of the object from the electronic device, the first signal being calculated based on a first transmission signal transmitted at a first time and a first reception signal received as the reflected wave of the first transmission signal,
the second signal intensity corresponding to the distance of the object from the electronic device, the second signal being calculated based on a second transmission signal transmitted at a second time earlier than the first time and a second reception signal received as the reflected wave of the second transmission signal.
